(19) United States
(12) Patent Application Publication
(10) Pub. No.: US 2015/0247933 A1
(43) Pub. Date: Sep. 3, 2015

(54) SPECTROMETRIC PERSONAL RADIATION DETECTOR - RADIOISOTOPE IDENTIFIER

(71) Applicant: Galaxray, LLC, Las Vegas, NV (US)

(72) Inventors: Dwight McQuirter, Diamondale, MI (US); Paul McQuirter, Rochester, MI (US); Vladislav Kondrashov, Mississauga (CA)

(21) Appl. No.: 14/313,473

(22) Filed: Jun. 24, 2014

Related U.S. Application Data
(60) Provisional application No. 61/840,236, filed on Jun. 27, 2013.

(51) Int. Cl. G01T 1/02; G01T 1/36

(52) U.S. Cl. CPC G01T 1/026; G01T 1/366

(57) ABSTRACT

Disclosed is a mobile and miniature radionuclide detection and identification system that has a processor and a quasi-hemispherical cadmium zinc telluride (CZT) component. The processor and the storage medium are surrounded by a housing and the storage medium contains a library of radionuclides. A graphic user interface is integral to the surface of the housing and the graphic user interface includes a touch sensitive display. In order to detect a radionuclide, the CZT component sends a signal to the processor, which then queries the library of radionuclides to identify a possible radionuclide.

### TECHNICAL FIELD

The subject matter of this document relates to a small form factor radioisotope detection and identification system and method.

### BACKGROUND

Electronic devices, including handheld electronic communication devices, have gained widespread use and may provide a variety of functions including, for example, telephonic, electronic text messaging, personal information manager (PIM) application functions, mobile web browsing, and audio and video playback, among other things. Input to these devices can be provided through various components including touchscreens, keyboards, microphones, proximity sensors, cameras and accelerometers. Maintaining functionality while using fewer or simpler components is generally desirable

Radioisotope detectors using cadmium zinc telluride (CZT) have high sensitivity to x-rays and gamma-rays, due to the high atomic numbers of cadmium and Telluride. CZT detectors have better energy resolution than scintillator detectors. CZT can be formed into different shapes for different radiation-detecting applications.

Various CZT detectors of different designs and sizes are widely and successfully used for different applications due to the favorable detection properties of CZT detectors. Among them there are hemispherical or quasi-hemispherical detectors. These detectors have a rather simple design and do not require special electronics for application. Development of quasi-hemispherical detectors' fabrication methods allows noticeable improvements in a detector's spectrometric performance due to a charge collection optimization. This will allow increasing the yield of high quality detectors. For example energy resolution at 662 keV line and peak-to-Compton ratio of the quasi-hemispherical detector with volume of 150 mm³ were improved from 27 keV and 2.5 to 13 keV and 4.9 correspondingly.

### SUMMARY

A CZT detector, is a direct-conversion based detector. A CZT detector allows for a much thinner apparatus than prior art detectors. In a direct conversion detector like a CZT detector, the radiation deposits energy at some point in the CZT detector's crystal lattice where it results in the generation of pairs of charge carriers. By application of an electric field, the charge carriers get swept to the cathode and anode of the device where they induce a current pulse that can be detected.

The present system provides the ability to search for and locate radioactive material and to identify radionuclides present in the material and assess associated risk of the material. The system can be embodied in a fully mobile handheld unit.

The disclosed mobile and miniature radionuclide detection and identification system has a processor, a quasi-hemispherical cadmium zinc telluride (CZT) component, and a storage medium. The processor and the storage medium are surrounded by a housing and the storage medium contains at least one library of radionuclides. The number of libraries is theoretically unlimited, but from a practical stand point the present system employs just one to three libraries. A graphic user interface is integral to the surface of the housing and the graphic user interface includes a touch sensitive display. In order to detect a radionuclide, the CZT component sends a signal to the processor, which then queries one or a plurality of the library of radionuclides to identify a possible radionuclide. The libraries of radionuclides contains a plurality of estimates of gamma-peak energies of a plurality of radionuclides.

### BRIEF DESCRIPTION OF THE DRAWINGS

FIG. 1. shows an embodiment of the mobile and miniature radionuclide detection and identification device;

FIG. 2 shows an embodiment of the mobile and miniature radionuclide detection and identification device displaying a dose rate graphical profile of a detected radionuclide;

FIG. 3 shows an embodiment of the mobile and miniature radionuclide detection and identification device displaying a spectrum acquisition curve; and

FIG. 4 shows an embodiment of the mobile and miniature radionuclide detection and identification device displaying a settings screen.

### DETAILED DESCRIPTION

Disclosed is a mobile and miniature radionuclide detection system that has a processor, a quasi-hemispherical cadmium zinc telluride (CZT) component, and a storage medium. The processor and the storage medium are surrounded by a housing and the storage medium contains a library of radionuclides. A graphic user interface is integral to the surface of the housing and the graphic user interface includes a touch sensitive display. In order to detect a radionuclide, the CZT detector is excited, which creates an electrical signal that is sent to the processor. The processor then queries the library of radionuclides to identify a possible radionuclide. The libraries of radionuclides contains a plurality of estimates of gamma-peak energies of a plurality of radionuclides.

The size of the mobile and miniature radionuclide detection system is relatively small in comparison to prior art radionuclide detection devices. The present inventive system can be embodied in an apparatus having as its dimensions: a length of no more than approximately five and one quarter inches (100 mm); a width of no more than approximately three inches (75 mm); and a height of no more than approximately one inch. It follows that, even including weight of the various batteries described below, the overall weight of an entire apparatus embodying the present system can be limited to no more than about a half pound (0.2 kg). The display screen in an apparatus embodying the present system is no more than about three and a half inches diagonally.

The basic system is a single detector system that has a CZT detector for high energy resolution and sensitivity. The system has two primary radiation monitoring functions: 1) search and dose; and 2) identification.

For search/dose, the system acts as radiation search/survey meter displaying a current dose rate and count rate. A variable-tone audio will indicate radiation intensity with an automatic audio meter or user adjusted alarm level. A “chart-record” of the a predetermined amount of data points can be displayed on the screen during the search. This mode is typically used to search for radioactive material or to carry out Total-Count Search. This mode also displays the current dose rate in Sieverts per hour (Sv/h) as well as cumulated from the time the mode was engaged. The dose meter is used to determine the relative hazard level and to assess handling requirements of a radioactive material.

After the system powers on, the search/dose feature of the system is activated automatically. The system display will show the current dose rate in Sv/h and count rate in counts/sec while the internal “audio meter” will give an audio response with the audio signal frequency related to radiation intensity.

In the identification mode, the system accumulates spectral data from a sample and analyzes the spectrum in terms of emitted energy and net count contribution. The radionuclides responsible for producing the spectrum are identified by comparison to a radionuclide library and presented in tabular form on a screen. This essential information can then be used to determine risk. As the spectrum is being accumulated, the spectrum is displayed on the screen so a user can observe the development of the spectrum as time progresses. At the end of the sample period, peak analysis radionuclide identification is automatically displayed on the screen. The accumulated spectrum is then automatically stored. All spectrums are stored for later analysis when output to a PC. The system includes a flash memory as an internal memory unit. If the internal memory of the unit is full, the system will display a message that the unit is full and the spectrum needs to be offloaded.

The storage medium contains at least one library of radionuclides. Each library is determined analytically via the method disclosed in Librarian Driven Analysis with Graphic User Interface for Nuclides Quantification by Gamma Spectra by Kondrashov, Rothenberg and Petersone, the entire contents of which are hereby incorporated by reference.

According to the method disclosed by Kondrashov et al., for a set of a priori given radionuclides extracted from a general nuclide data library, median estimates of gamma-peak areas and estimates are used to produce a list of possible radionuclides matching gamma-ray line(s). An a priori determined list of nuclides is obtained by searching for a match with the energy information of the database. This procedure is performed in an interactive graphic mode by markers that superimpose, on the spectral data, the energy information and yields provided by a general gamma-ray library. This library of experimental data includes approximately 17,000 gamma-energy lines related to 756 known gamma emitter radionuclides.

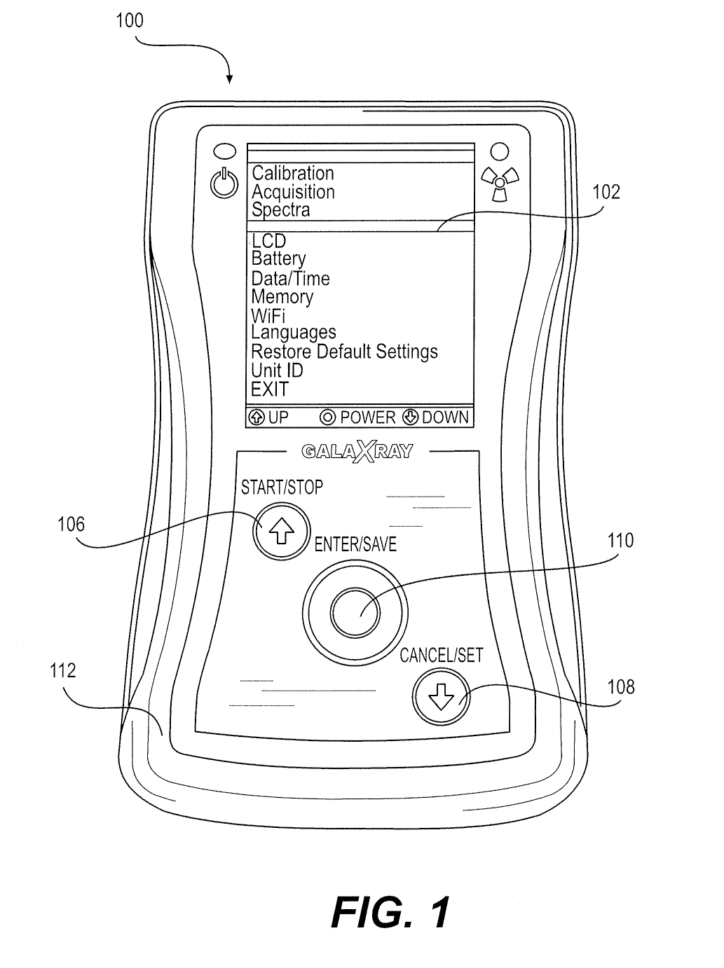

An apparatus embodying the presently disclosed system is shown in FIG. 1 as apparatus 100 having a single rugged plastic housing 112. The housing 112 has an option for the apparatus 100 to be mounted on a person via a belt clip (not shown) for ease of carrying during a constant dose monitoring situation.

As already stated, the detector is a cadmium zinc telluride (CZT) detector. A 0.5 cm³ CdZnTe semiconductor crystal is used for the detection of gamma radiation and provides a high resolution signal for the system's radionuclide identification capability. CZT is a specialized detector with a resolution several times better than that of widely used inorganic scintillators (i.e. Sodium-Iodide, Cesium-Iodide) thus allowing discrimination of gamma-peaks that are impossible to see on a scintillation-based detector. The detector is strategically mounted on the front of the apparatus 100 for ease of usage.

The apparatus 100 has three operating control buttons 106, 108 and 110. The buttons 106, 108 and 110 are all enclosed in a plastic membrane 112. All system functions are controlled by the three buttons 106, 108 and 110, which permits very easy instrument handling. The buttons are specially arranged for ease of use and to toggle between a menu and operational options with three actions—UP, DOWN, and ENTER. The three buttons 106, 108 and 110 on the instrument face are the only mechanical controls for the apparatus 100.

A color LCD 102 permits a full range of alphanumeric and graphic display capabilities. This LCD gives excellent contrast in high light conditions. The apparatus 100 also incorporates automatic temperature compensation to maintain correct contrast even when the external temperature substantially changes.

The apparatus embodiment of the system has a much lower power requirement than prior art radionuclide detection and identification systems. Previous systems were quite consuming, having a typical constant running time life of no more than about three or four hours. The present system has integrated battery-charging capability and operates with an internal lithium ion battery. The internal battery charger permits the battery charging system to be fully under software control. The user also has the option of running the system on regular non-rechargeable batteries. The user simply selects battery type and the charger automatically selects the correct charging parameters or chooses the no-charge option. In other embodiments, power for the apparatus is generated by a single lithium ion battery.

The system is operable on two AA-cell batteries. Two types of batteries can be used. A standard nickel-metal hydride rechargeable battery which provides 16 hours of normal operation for the system when fully charged. Alkaline batteries may also be used. Alkaline batteries can provide 8 hours of normal operation for the system. The selection of alkaline prevents charging of the battery from the internal charger. When the system is charging, the display will indicate the charging status along with an indication when the battery is fully charged. The display has a backlight (not shown). Without the system's backlight in use the system can typically be powered for about eight hours at twenty-five degrees centigrade. Preferred operating temperature range is between 10° C. to over 50° C.

The system is rechargeable via a USB connection to a wall outlet or a PC. The same USB connection is also used to transfer dose, spectrum and other data to and from a PC. A USB connection is not necessary to offload information to a PC as a Wi-Fi connection can be used to transfer data between the system and a PC or other processing and storage system, i.e., cloud storage.

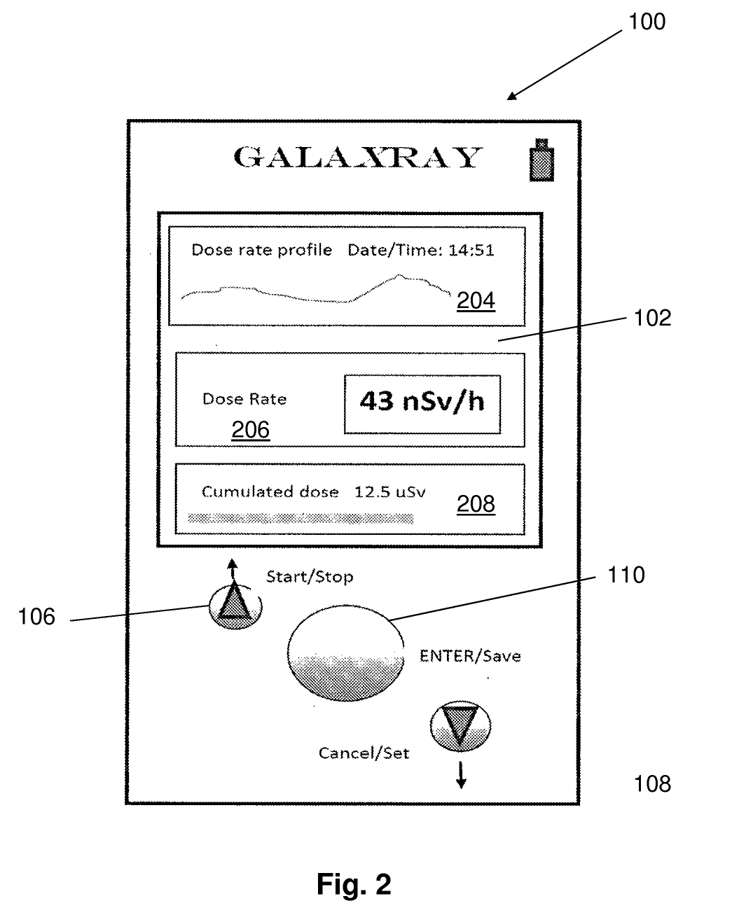

As shown in FIG. 2, the present apparatus 100 includes the display 102 and shows the apparatus 100 in a search/dose mode. Top curve 204 shows a dose rate graphical profile of a detected radionuclide dose rate along with the current date/time. The second window 206 displays the current dose rate as detected by the apparatus 100. Using these two windows 204 and 206, a person can easily identify the direction of the source before the spectrum is acquired and a source identification is performed. The last box 208 shows the accumulated dose over the time period selected by the user in the setting screen as described in the parameter setting screen section (introduced below). The accumulated dose bar shown in the figure is in a logarithmic scale since the accumulated dose threshold is relatively large in comparison with dose rate. The dose profile, dose rate and cumulated dose will always be calculated and displayed when the system is in the search/dose screen. The user can just watch the current dose rate, and the cumulative dose from screen 1 without recording.

The apparatus can save as many as twenty-four hours of dose rate records. To begin recording the dose time profile from the display 102, a person presses the ‘Start/Stop’ (Up arrow) button 106. The dose rate time profile is recorded into the apparatus's memory for a preset time as selected in the settings window. The message ‘dose recording.’ will appear on screen within a pop up window. The dose record time can be set from 10 seconds to 24 hours according to the following parameters: 10 s, 30 s, 60 s, 100 s, 300 s, 1000 s, 1 hr, 2 hr, 8 hr, 12 hr, 24 hr. When the Dose record time has expired, the message: “Dose rate saved”, is displayed accompanied with a single beep or series of beeps depending on user preference.

A cumulative dose alarm threshold fort can be predetermined for the system. For example, the alarm can be set to alert a user at: 1 μSv, 5 μSv, 10 μSv, 50 μSv, 100 μSv, 1 mSv, 10 mSv, 100 mSv, 250 mSv. Upon reaching this level the message “Cumulative dose alarm” will appear in a pop up window. The apparatus 100 includes a vibrate alarm as well as a beep alarm and a visual color coded alarm. As such, the alarm LED will turn from green to red and the system will beep/vibrate if a sound/vibrate parameter is set to ON.

Similarly, a saturation level alarm can be set at 20 mSv/h. For safety concerns, this parameter should not be made adjustable. It is the calculated saturation level of the CZT detector. Upon reaching this level the message “Saturation level>20 mSv/h” should be displayed. The Alarm LED will turn from green to red and the unit will beep and vibrate.

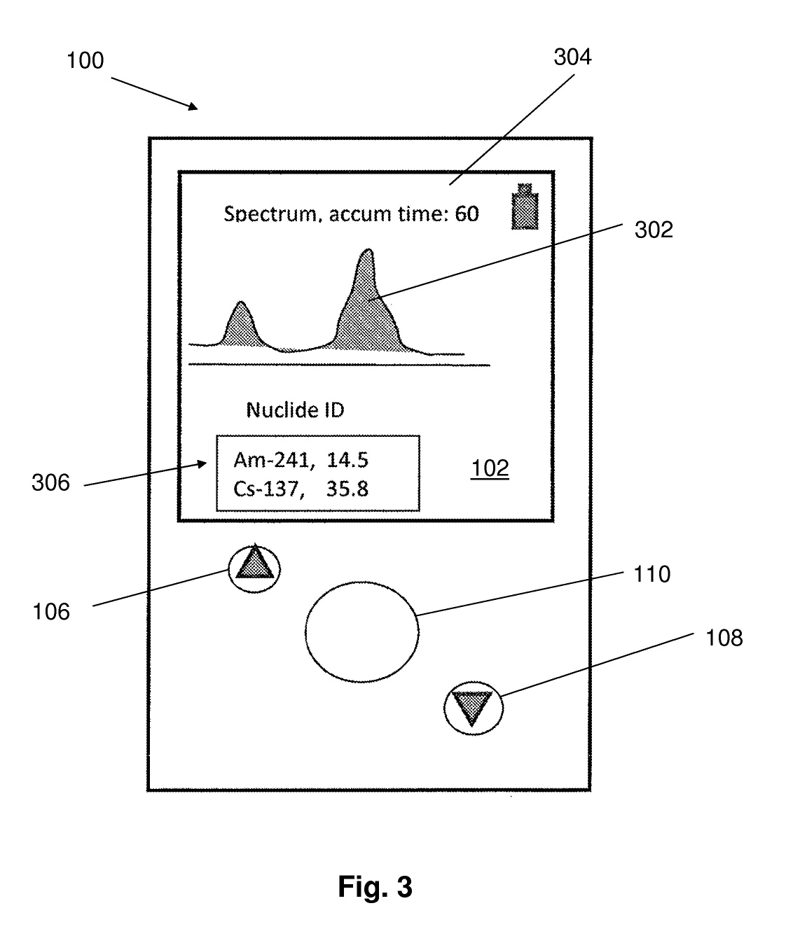

The spectrum identify mode is used to display the spectrum of the radiation isotope being monitored and to use the internal library to help identify the isotope. In FIG. 3, the top curve shows a spectrum 302 as it is accumulated along with acquisition time 304 of the spectrum 302. Below the spectrum, the radionuclide identification 306 is displayed (if it has been determined).

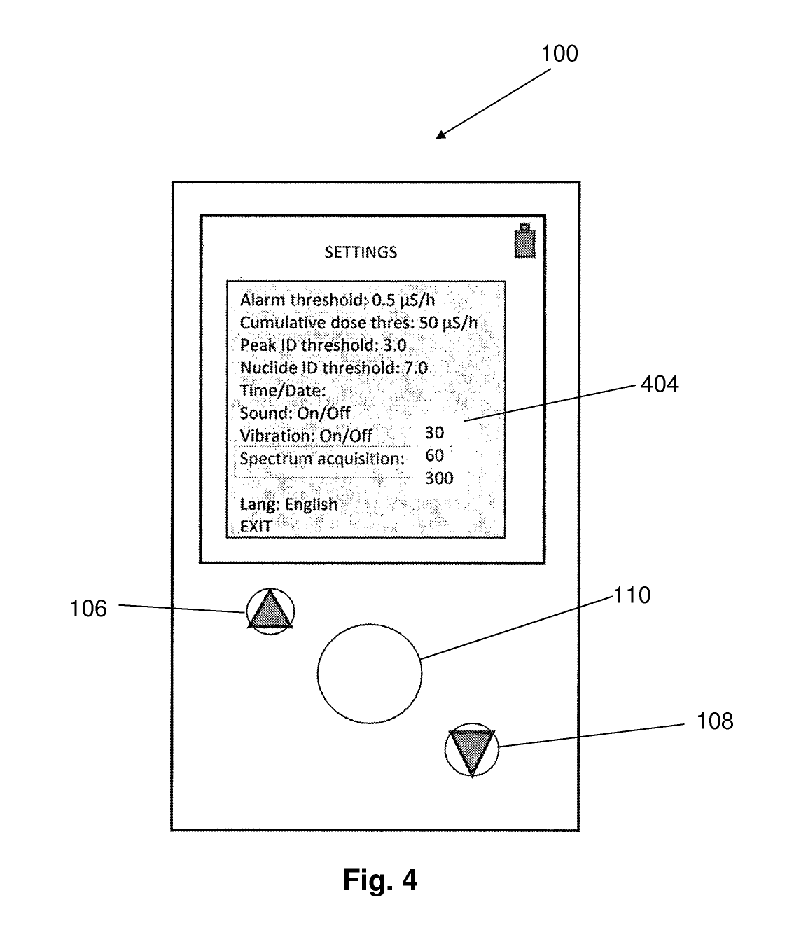

To begin spectrum acquisition on screen, the user must press the ‘start/stop’(up arrow) button 106. The spectrum will be recorded for the preset time as selected in the settings screen 404 (see FIG. 4). If the user desires, they can stop acquisition at any time and get the results of radionuclide identification by pressing the ‘start/stop’ button 106 again. Otherwise the radionuclide identification will be displayed on completion of the spectrum acquisition time. After stopping spectrum acquisition, the intermediate results of the radionuclide identification analysis will be displayed in the radionuclide identification box in a selectable format. For example, a user might be interested in a highlighted radionuclide identification, category, strength or some combination of the three. As many as five radionuclides can be displayed in the display screen. If there are more than five radionuclides, the user will be able to be scroll down through the complete list of possibilities. If no identification can be made, the system indicates a message of “NOT IN LIBRARY,” which simply means that the analysis routines found no identifiable radionuclides.

Once the system stops spectrum acquisition, the screen shown in FIG. 3 will appear on the screen. If the results of the spectrum acquisition look like the curve 302 in FIG. 3, then the list of isotopes will become active. To navigate through the list of isotopes the user can press the ‘up’ or ‘down’ buttons 106 and 108 to scroll through the list of possible isotope matches. Once the spectrum display becomes active, the user can move the spectral cursor along the energy axis by using the ‘up’ button 106 to move left and the ‘down’ button 108 to move the cursor to the right.

The system can be programmed to attempt spectrum accumulation for a desired amount of time, for example: 10 s, 30 s, 60 s, 100 s, 300 s, 1000 s, 1 hr, 2 hr. Upon time expiration, the message “Spectrum saved” is displayed accompanied with at least a single beep (if the system's sound feature is set to “ON”).

The CZT detector has a one half cubic centimeter volume. Typically, the dimensions of the CZT detector are 5×10×10 mm. Detector resolution is usually Cs-137. The maximum resolution full width at half maximum (FWHM) @ 662 keV should be less than five percent—typically 3% at room temperature.

Quasi-hemispherical detectors have a rather simple design and do not require special electronics for application. Development of quasi-hemispherical detectors' fabrication methods has allowed noticeable improvements in the detector's spectrometric performance due to a charge collection optimization. This allows the ability to increase the yield of the present detector.

In search mode, the radiation data from the high-sensitivity CZT detector is used to create an audio search capability thus permitting the user to have an “eyes-free” operational mode. The system scans all incoming data and converts the radiation field into a mode that changes the frequency of the audio tone to reflect the radiation field intensity. Various parameters are used to adjust system performance to suit the user. In the majority of cases the system's audio feature allows for occasional “beeps” of low intensity audio on normal background (this shows the user that the audio system is alive) but in the presence of a real radioactive field the audio frequency changes rapidly. With this feature, it is very easy to scan back and forth through data saved in the system as well as back and forth through the user's geographical area to readily locate the highest audio pitch, which is the maximum radiation intensity and the source of the system's excitation.

The present system includes an active dosimeter. The dosimeter's energy range is between 20 keV and 3 MeV set during manufacture of the system. The measuring range is between 10 nSv/hr-30 mSv/hr. Depending on the isotope, the system may overload at the higher level at a different rate. System overload will happen when radiation dose too high (for example, over 20 mSv/hr). The system's measurement accuracy is within +/−20% in 1.0 μSv/hr radiation field

Due to the CZT detector and the stored nuclide libraries, simultaneous detection of an isotope and determination of the type of the isotope is possible with the present inventive subject matter. As a result, the present subject matter enables hazard identification and risk assessment in a handheld device. The energy must be compensated. Energy compensation means that energy of gamma-photons is taken into consideration for radiation dose assessment.

Although the invention is illustrated and described herein with reference to specific embodiments and illustrations, the invention is not intended to be limited to the details shown herein. Rather, various modifications and alterations may be made in the details within the scope and range of equivalents of the claims and without departing from the invention.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

We claim:

1. A mobile and miniature radionuclide detection and identification system comprising:
a processor, a quasi-hemispherical cadmium zinc telluride (CZT) detector, and a storage medium,
a housing surrounding the processor, the detector and the storage medium, the storage medium comprising at least one library of radionuclides comprising a plurality of estimates of gamma-peak energies of a plurality of radionuclides; and
a graphic user interface embedded within the housing;
wherein an identity and a dose of a detected radionuclide is identified by matching a peak area of a measured spectrum to the peak areas of the plurality of radionuclides in the library of radionuclides.

2. The mobile and miniature radionuclide detection and identification device as recited in claim 1 wherein the CZT detector comprises a maximum volume of 0.5 cm³.

3. The mobile and miniature radionuclide detection and identification device as recited in claim 2 wherein the display is no more than 3.5 inches diagonally.

4. The mobile and miniature radionuclide detection and identification device as recited in claim 3 wherein the device is configured to simultaneously detect an isotope, determine a type of the isotope and determine a radiation dose.

5. The mobile and miniature radionuclide detection and identification device as recited in claim 3 wherein the display is an LCD color display.

6. The mobile and miniature radionuclide detection and identification device as recited in claim 1 further comprising a power source for providing a voltage of 1.2 volts.

7. The mobile and miniature radionuclide detection and identification device as recited in claim 5 wherein the power source is selected from the group consisting of a lithium-ion battery, an alkaline battery, an NiMH battery, an AC source and any combination thereof.

8. The mobile and miniature radionuclide detection and identification device as recited in claim 1 wherein the processor is configured to enable selective operation of the power source provides.

9. The mobile and miniature radionuclide detection and identification device as recited in claim 1 further comprising a flash memory.

10. The mobile and miniature radionuclide detection and identification device as recited in claim 1 further comprising a dosimeter

11. The mobile and miniature radionuclide detection and identification device as recited in claim 10 wherein the dosimeter is an active dosimeter.
